(19) United States
(12) Patent Application Publication
(10) Pub. No.: US 2017/0091615 A1
(43) Pub. Date: Mar. 30, 2017

(54) SYSTEM AND METHOD FOR PREDICTING POWER PLANT OPERATIONAL PARAMETERS UTILIZING ARTIFICIAL NEURAL NETWORK DEEP LEARNING METHODOLOGIES

(71) Applicant: Siemens Aktiengesellschaft, Munich (DE)

(72) Inventors: Jie Liu, Bethlehem, PA (US); Ioannis Akrotirianakis, Princeton, NJ (US); Amit Chakraborty, East Windsor, NJ (US)

(21) Appl. No.: 14/867,380

(22) Filed: Sep. 28, 2015

(51) Int. Cl. G06N 3/04; G06N 3/08

(52) U.S. Cl. CPC G06N 3/0481; G06N 3/08

(57) ABSTRACT

A system and method of predicting future power plant operations is based upon an artificial neural network model including one or more hidden layers. The artificial neural network is developed (and trained) to build a model that is able to predict future time series values of a specific power plant operation parameter based on prior values. By accurately predicting the future values of the time series, power plant personnel are able to schedule future events in a cost-efficient, timely manner. The scheduled events may include providing an inventory of replacement parts, determining a proper number of turbines required to meet a predicted demand, determining the best time to perform maintenance on a turbine, etc. The inclusion of one or more hidden layers in the neural network model creates a prediction that is able to follow trends in the time series data, without overfitting.

### BACKGROUND

1. Technical Field

Aspects of the present invention relate to predicting various operational measures of a power plant (e.g., operating hours, energy load, etc.) and, more particularly, to using an artificial neural network approach to perform the prediction, utilizing a deep learning methodology to provide accurate predictions based on the time series data involved in power plant control.

2. Description of Related Art

In the operation of power plants, the ability to accurately solve forecasting problems is important for decision makers, in order to reasonably make plans about production for the next period of time. In order to satisfy the customers, power plants need to produce enough electricity to meet their needs, while not producing too much more than the actual demand (since there is no ability to store excess energy). Producing either too little or too much energy thus harms the power plant's ability to make a profit. As a result, predictive analytics of time series has become a crucial topic in making decisions in operating power plants.

Because most power plants rely on gas turbines to generate electricity, it is important to perform periodic maintenance events so that the turbines can function well and work longer. There are three aspects of gas turbines that are continuously under study and for which predictive analytics is an important tool: (1) accurate predictions of the daily energy load (this is associated with determining the number of turbines to turn “on” each day); (2) accurate predictions of the “demand” (in terms of the monthly operating hours and maintenance events) so that sufficient fuel and other resources are available; and (3) accurate predictions of inventory required for replacement parts. This last category is important, since it is difficult to know which parts may be damaged during different processes. Thus, if it is possible to predict the numbers of various parts that are replaced during a given period of time, the inventory can be ordered and on-hand in a most cost-efficient (as well as time-efficient) manner.

Without any additional information beyond the historical time series data regarding power plant operation parameters such as (but not limited to) energy load, demand (i.e., operating hours) and “parts replacement”, it appears to be very difficult to predict actions going forward, since the time series for these do not seem to show any obvious regularity.

### SUMMARY

The needs remaining in the art are addressed by aspects of the present invention, which relate to predicting various operational parameters of a power plant (e.g., operating hours, energy load, etc.) and, more particularly, to using an artificial neural network approach to perform the prediction, utilizing a deep learning methodology to provide accurate predictions based on the time series data involved in power plant control.

In accordance with aspects of the present invention, time series data associated with power plant operations (e.g., operating hours, energy demand, part replacement schedule, and the like) is utilized as an input to an artificial neural network model that includes a “deep learning” process in the form of at least one additional (hidden) layer of network elements that processes the time series input data and provides a forecasted time series (prediction) as an output. The deep learning topology can be configured in either of a feedforward neural network or a recurrent neural network. The output predictions are used by power plant personnel to schedule the proper resources (turbines, fuel, spare parts, and the like) for the following time period.

In performing the time series prediction in accordance with aspects of the present invention, the sizes of the training data sets and testing data sets are important factors in providing accurate predictions. The training set is applied as an input to a selected network topology, and is used in an iterative manner to determine the optimum values of the weights and biases within the network. In an exemplary embodiment, a relatively large training set and a moderately-sized testing set are used to predict the future values of the time series data. In terms of the number of “steps ahead” created by the prediction, it was found that for larger time series, the best predictions were created for a smaller number of steps ahead. Also, while it is possible to use either a feedforward neural network (FFNN) or a recurrent neural network (RNN) in performing the prediction, the RNN model tends to provide the more accurate results in most cases.

In one embodiment, aspects of the present invention take the form of a method of scheduling future power plant operations based on a set of time series data associated with a specific power plant operation comprising: (1) selecting an artificial neural network model for use in evaluating the set of time series data, the selected artificial neural network model including at least one hidden layer between an input layer and an output layer, the input layer for receiving a set of time series datapoints and the output layer for generating one or more predicted time series values; (2) initializing the selected artificial neural network model by defining a number of nodes to be included in each layer, an activation function for use in each neuron cell node in each layer, and a number of bias nodes to be included in each layer; (3) training the selected artificial neural network model to develop an optimal set of weights for each signal propagating through the network model from the input layer to the output layer, and an optimal set of bias node values; (4) defining the trained artificial neural network as a prediction model for the set of time series data under study; (5) applying a newly-arrived set of time series data to the prediction model; (6) generating one or more predicted time series data output values from the prediction model; and (7) scheduling an associated operation event at the specific power plant based on the predicted time series data output values.

Another specific embodiment takes the form of a system for predicting future values of time series data associated with power plant operation and scheduling a future event based on the predictions, the system including a scheduling module responsive to input instructions for performing a selected power plant operation forecast. The scheduling module itself includes a memory element for storing time series data transmitted from one or more power plant to the scheduling module, a processor and a program storage device, the program storage device embodying in a fixed tangible medium a set of program instructions executable by the processor to perform the inventive method as outlined above.

Other and further aspects and embodiments of the present invention will become apparent during the course of the following discussion and by reference to the accompanying drawings.

### BRIEF DESCRIPTION OF THE DRAWINGS

Referring now to the drawings,

FIG. 1 is a simplified diagram of a basic one cell neural network;

FIG. 2 is a diagram of an exemplary feedfoward neural network including two hidden layers;

FIG. 3 is a diagram of an Elman type of recurrent neural network;

FIG. 4 is a diagram of a Jordan type of recurrent neural network;

FIG. 5 is a flowchart of an exemplary process used to create a deep learning artificial neural network for forecasting power plant operation factors in accordance with aspects of the present invention;

FIG. 6 is a diagram of an exemplary dynamic training routine, including a walk forward set of training data, that may be used in create a power plant forecasting artificial neural network in accordance with aspects of the present invention;

FIG. 7 is a time series plot of historical energy load data for use in analyzing the forecasting properties of an artificial neural network configured in accordance with aspects of the present invention;

FIG. 8 is a diagram of an exemplary Elman-type recurrent neural network utilized in the analysis of the time series data (training information) shown in FIG. 7;

FIG. 9 is a table showing the various combinations of time series data used to provide the “training information” input to the network shown in FIG. 8;

FIG. 10 is a graph depicting the variation in measured error as a function of different sizes of training data used in training the neural network;

FIG. 11 is a plot showing the correspondence between the “best” predicted energy load values and the “actual” load values for a time period included at the end of the plot of FIG. 7;

FIG. 12 is a graph showing a comparison of actual data to the validation data set when using a testing set having a size of 1% of the total amount of training information;

FIG. 13 is a graph showing a comparison of actual data to the validation data set when using a testing set having a size of 25% of the total amount of training information;

FIG. 14 is a graph showing a comparison of actual data to the validation data set when using a testing set having a size of 80% of the total amount of training information;

FIG. 15 is a plot of calculated errors as a function of the number of “steps ahead” calculated by the network of FIG. 8;

FIG. 16 is plot of “small data”, in this case a plot of gas turbine ring segment failures over a time period of 41 months;

FIG. 17 is a plot comparing the predicted values for months 30-41 of the plot of FIG. 16 (using the network of FIG. 8) to the actual known values, based on a single-step-ahead model;

FIG. 18 is a plot similar to FIG. 17, but in this case based on using a two-step-ahead model;

FIG. 19 is a plot of equivalent hours of power plant operation over a time period of 49 months;

FIG. 20 is a plot of predicted future equivalent hours, determined by using an exemplary feedforward neural network;

FIG. 21 is a plot of predicted future equivalent hours, determined by using an Elman-type recurrent neural network;

FIG. 22 is a plot of the numerical results for the time series shown in FIG. 7, as a function of varying the complexity of the neural network utilized to generate the forecasted values;

FIG. 23 is a diagram of an exemplary system that may be used to perform the power plant forecasting processes of aspects of the present invention.

### DETAILED DESCRIPTION

Prior to describing the details of applying deep learning methodologies to the problem of predicting operation conditions of a power plant, the following discussion begins with a brief overview of basics of artificial neural networks, particularly with respect to the subject of deep learning.

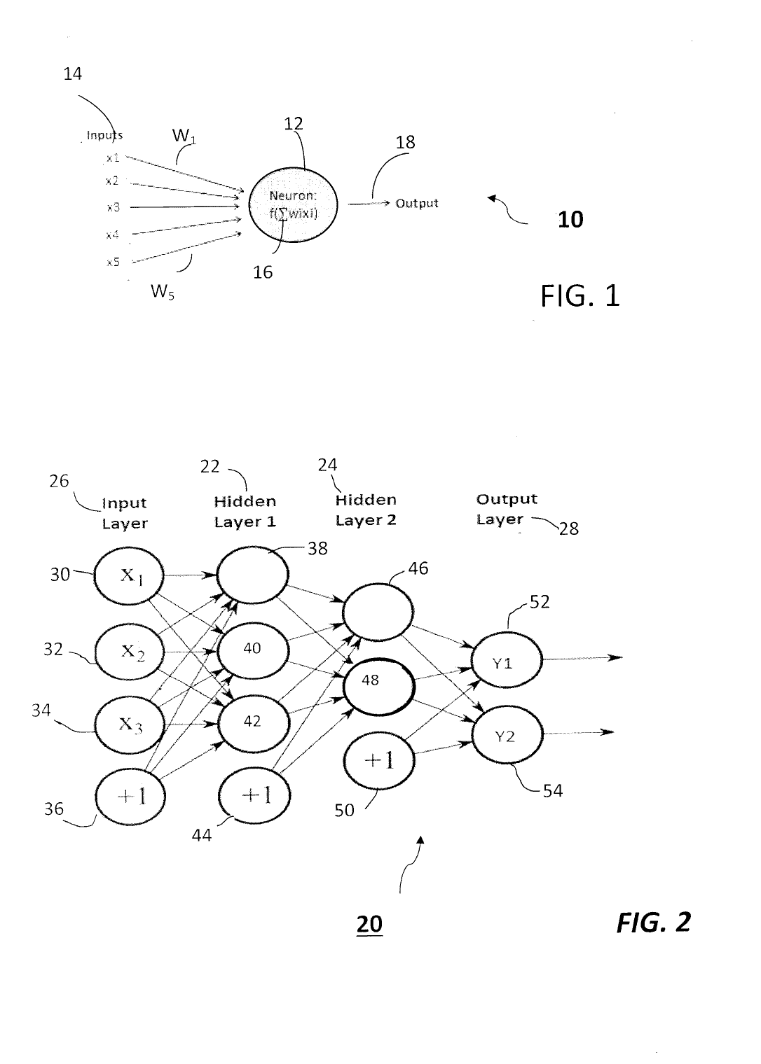

Artificial neural networks are known as abstract computational models, inspired by the way that a biological central nervous system (such as the human brain) processes received information. Artificial neural networks are generally composed of systems of interconnected “neurons” that function to process information received as inputs. FIG. 1 shows a basic artificial neural network 10 that includes a neuron cell 12. Neuron cell 12 functions similarly to a cell body in a neuron of a human brain and sums up a plurality of inputs 14 (here, shown as x₁, x₂, . . . , x₅) with possibly different weights wᵢ (i=1, 2, . . . , 5) applied to each input (also defined as “arc weights”), as shown along the toward neuron ell 12. The set of weighted inputs is then summed and subjected to a defined activation function 16. The result from the activation function is then provided as the output 18 from neuron cell 12. Output 18 may then be transmitted and applied as an input to other neuron cells, or provided as the output value of the artificial neural network itself.

Artificial neural networks may be configured to include additional layers between the input and output, where these intermediate layers are referred to as “hidden layers” and the deep learning methodology relates to the particular ways that these hidden layers are coupled to each other (as well as the number of nodes used in each hidden layer) in forming a given artificial neural network. FIG. 2 illustrates an exemplary artificial neural network 20 that includes a first hidden layer 22 and a second hidden layer 24 positioned in the network between an input layer 26 and an output layer 28.

In this particular configuration, neural network 20 is referred to as a “deep feedforward network with two hidden layers” (or a “deep learning” neural network). In this feedforward neural network (FFNN), the signals move in only one direction (i.e. “feed in the forward direction”) from input layer 26, through hidden layers 22 and 24, and ultimately exiting at output layer 28. In each layer, only selected nodes function as “neurons” in the manner described above in association with FIG. 1. Input layer 26 consists of input neuron cells, shown as nodes 30, 32, and 34 in this network. A bias node 36 (designated as “+1”) is also included within input layer 26. First hidden layer 22 is shown as including a set of three neuron cells 38, 40 and 42, each processing the collected set of weighted inputs by the defined activation function. A bias node 44 also provides an input at hidden layer 22. The created set of output signals is then applied as inputs to second hidden layer 24.

Second hidden layer 24 itself is shown as including a pair of neuron cells 46, 48 (as well as a bias node 50), where as explained above, each neuron cell applies the activation function to the weighted signals arriving as inputs. The outputs created by these neuron cells are shown as being applied as input signals to neuron cells 52 and 54 of output layer 28. Again, the activation function is associated with each neuron cell 52 and 54 and is applied to the weighted sum of the signals received from first hidden layer 22. The output signals produced by cells 52 and 54 are defined as the output signals of artificial neural network 20. In this case, the provision of two separate outputs defines this particular network configuration as providing a “two-step-ahead” forecast.

The number of hidden layers in a given deep learning feedforward network can be different for different datasets. However, it is clear from a review of FIG. 2 that the inclusion of additional hidden layers results in introducing more parameters, which may lead to overfitting problems for some predictive analytics applications. In addition, the use of a larger number of hidden layers also increases the computational complexity of the network. In accordance with aspects of the present invention, it is has been found that only one or two hidden layers is necessary to provide accurate time series predictions of power plant operations.

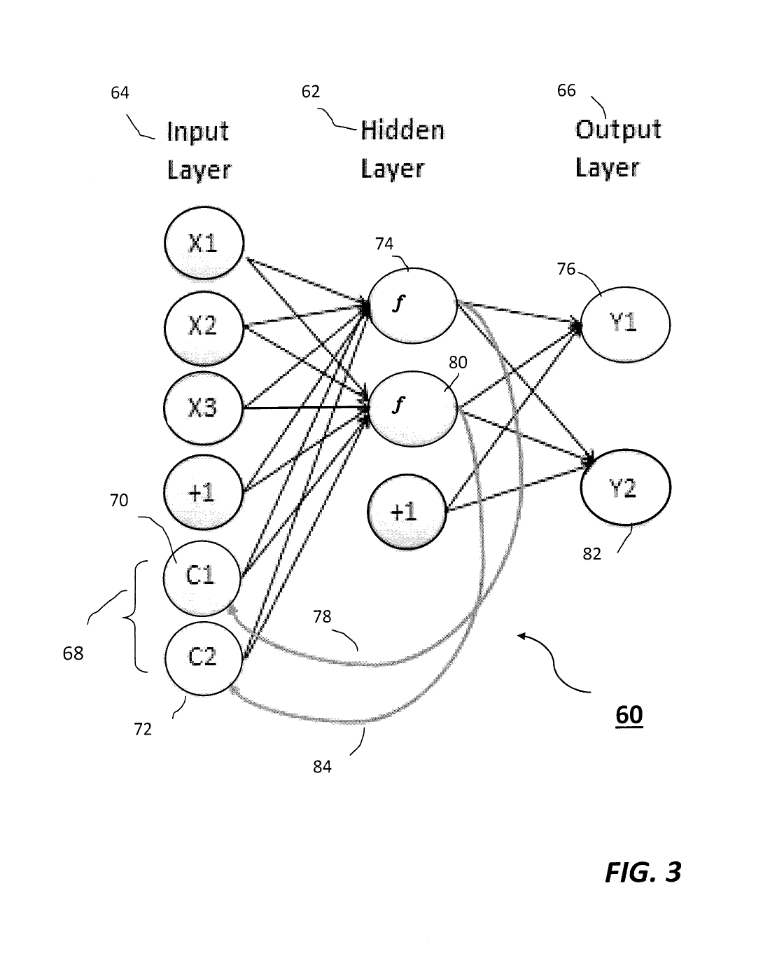

In contrast to the “feedforward” neural network shown in FIG. 2, it is possible to create networks that include “feedback” paths, where this type of artificial neural network is referred to as a “recurrent neural network” (RNN). A recurrent neural network is able to take into account the past values of the inputs in generating an output. Introducing greater history of the inputs into the process necessarily increases the input dimension of the network, which may be problematic in some cases. However, the ability to include this information tends to improve the accuracy of the predictions. FIG. 3 illustrates a first type of recurrent neural network, referred to in the art as an “Elman recurrent network” and is illustrated as network 60 in the configuration of FIG. 3.

As shown, recurrent neural network 60 consists of a single hidden layer 62 positioned between an input layer 64 and an output layer 66. Also included in recurrent network 60 is a context layer 68, which in this case includes a first context node 70 and a second context node 72. In this particular configuration of a recurrent network, the outputs from the hidden layer are fed back to context layer 68 and used as additional inputs, in combination with the newly-arriving data at input layer 64. As shown, the output from a first neuron cell 74 of hidden layer 62 is stored in first context node 70 (as well as being transmitted to a neuron cell 76 of output layer 66). A feedback arrow 78 shows the return path of signal flow from the output of neuron cell 74 to first context node 70. Similarly, the output signal created by a second neuron cell 80 of hidden layer 62 is stored in second context node 72 of context layer 68 (and also forwarded as an input to a neuron cell 82 in output layer 66). A feedback arrow 84 shows the return path of signal flow from the output of neuron cell 80 to second context node 72.

The previous output signals held in context nodes 70 and 72 (hereinafter referred to as “context values”), are then, together with the current training data values appearing as inputs x₁, x₂ and x₃ (as appropriately weighted) at the current time step, applied as inputs to neuron cells 74 and 80 of hidden layer 62. By incorporating the previous hidden layer output values with the current input values, it is possible to better predict sequences that exhibit time-varying patterns.

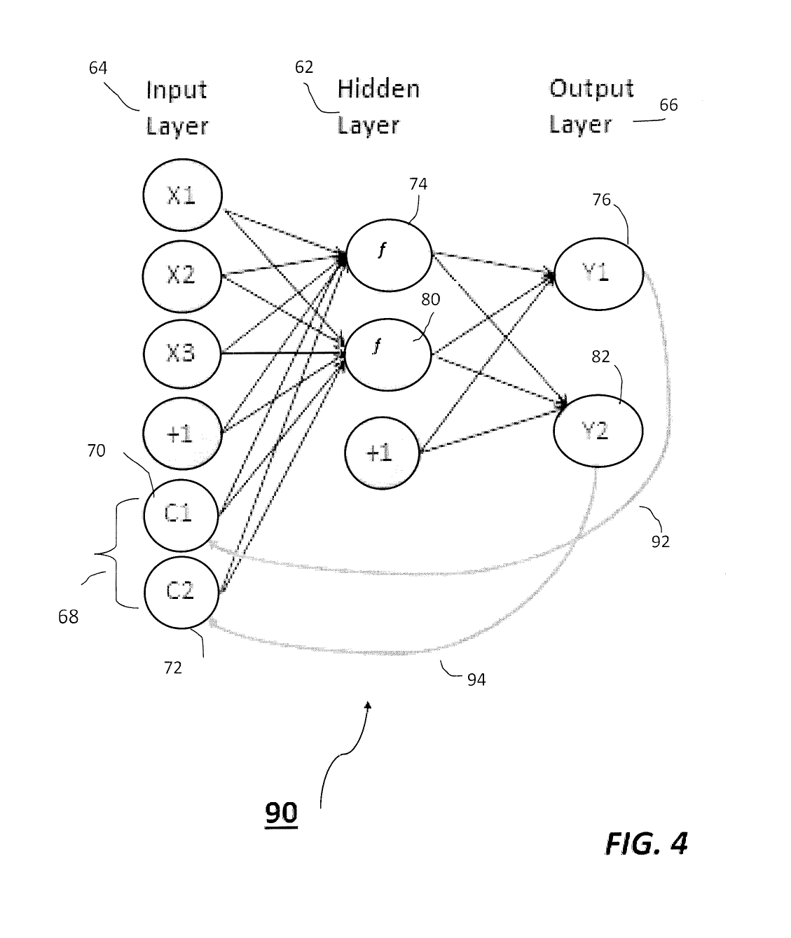

FIG. 4 illustrates a slightly different recurrent neural network 90, referred to in the art as a “Jordan recurrent neural network”. The various layers, nodes and neuron cells are the same as network 60 of FIG. 3, but in this case the feedback signals are taken from output layer 66 instead of hidden layer 62. This is shown in FIG. 4 as a first feedback path 92 returning a copy of first output signal Y1 to be stored in context node 70 and a second feedback path 94 returning a copy of second output signal Y2 to be stored in context node 72. In either case of recurrent network 60 or 90, the feedbacks provide a summary of information from the previous time step, exploiting some of the temporal structure that time series data presents.

In each of the various artificial neural networks described above, the neuron cells are described as applying an “activation function” (denoted as fin the drawings) to the collected group of weighted inputs in order to create the output signal. One common choice of activation function is the well-known sigmoid function f: [symbol] →[0,1], and defined as follows:

$$f ( z ) = \frac{1}{1 + {e}^{- z}} . \qquad ( 1 )$$

The derivative of the sigmoid function thus takes the following form:

f′(z)=f(z)(1−f(z)).

Another activation function used at times in artificial neural networks is the hyperbolic tangent function,

$$f ( z ) = tanh ( z ) = \frac{{e}^{z} - {e}^{- z}}{{e}^{z} + {e}^{- z}} , \qquad ( 2 )$$

which has an output range of [−1, 1] (as opposed to [0,1] for the sigmoid function). The derivative of the hyperbolic tangent function is expressed as:

f′(z)=1−(f(z))².

Other functions, such as other trigonometric functions, may be used as activation functions. Regardless of the particular activation function used, the output from a node (neuron) is defined as the “activation” of the node. The value of “z” in the above equations is defined as the weighted sum of the inputs in the previous layer.

For the power plant-related forecasting applications of aspects of the present invention, the inputs to the artificial neural network are typically the past values of the time series (for example, past values of energy demand for performing demand forecasting) and the output is the predicted future energy demand value(s). The predicted future energy demand is then used by power plant personnel in scheduling equipment and supplies for the following time period. The neural network, in general terms, performs the following function mapping:

yₜ₊₁=f(yₜ,yₜ₋₁, . . . ,yₜ₋ₘ),

where yₜ is the observation at time t and m is an independent variable defining the number of past values utilized in the mapping function to create the predicted value.

The following discussion of using a created artificial neural network model to predict future values of a power plant-related set of time series data values will utilize a feedforward neural network model, for the sake of clarity in explaining the details of the invention. It is to be understood, however, that the same principles apply to the utilization of a recurrent neural network in developing a forecasting model for power plant operations.

Before an artificial neural network can be used to perform electric load demand forecasting (or any other type of power plant-related forecasting), it must be “trained” to do so. As mentioned above, training is the process of determining the proper weights Wᵢ (sometimes referred to as arc weights) and bias values bᵢ that are applied to the various inputs at activation nodes in the network. These weights are a key element to defining a proper network, since the knowledge learned by a network is stored in the arcs and nodes in terms of arc weights and node biases. It is through these linking arcs that an artificial neural network can carry out complex nonlinear mappings from its input nodes to its output nodes.

The training mode in this type of time series forecasting is considered as a “supervised” process, since the desired response of the network (testing set) for each input pattern (training set) is always available for use in evaluating how well the predicted output fits to the actual values. The training input data is in the form of vectors of training patterns (thus, the number of input nodes is equal to the dimension of the input vector). The total available data (referred to at times hereinafter as the “training information”) is divided into a training set and a testing set. The training set is used for estimating the arc weights and bias values, with the testing set then used for measuring the “cost” of a network including the weights determined by the training set. The learning process continues until a set of weights and bias node values is found that minimizes the cost value.

It is usually recommended that about 10-25% of the time series data be used as the testing set, with the remaining data used as the training set, where this division is defined as a typical “training pattern”.

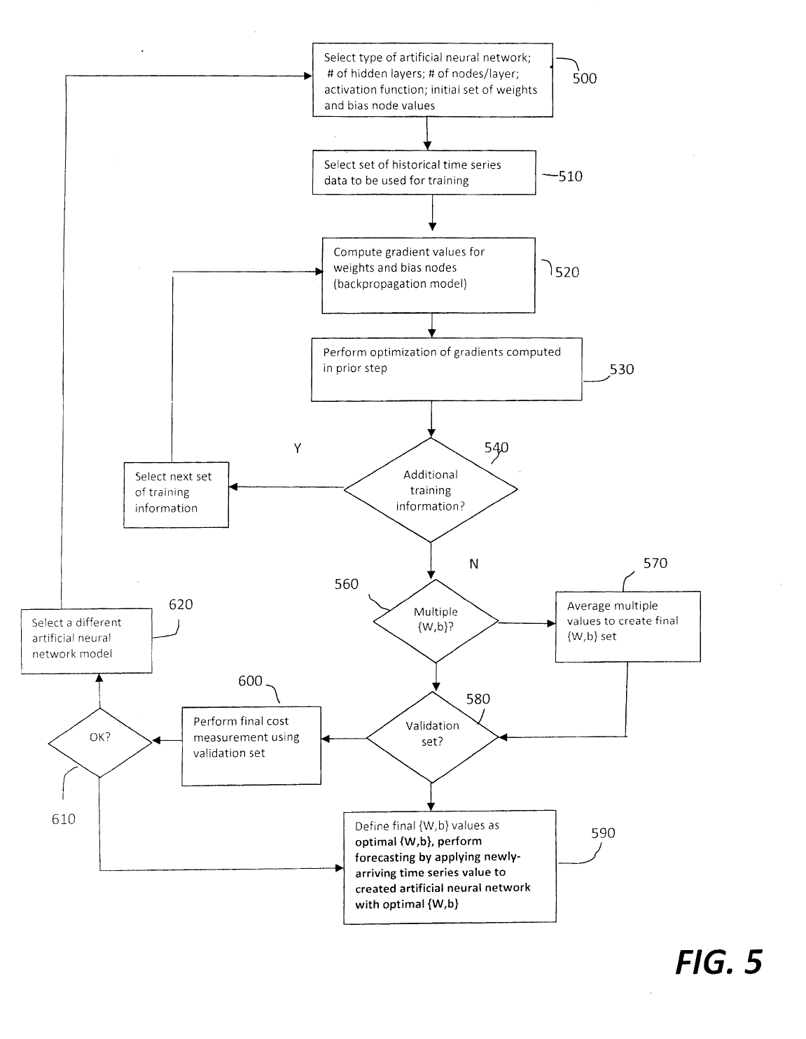

At a high level, the methodology utilized in accordance with aspects of the present invention to obtain a “deep learning” neural network model useful in performing time series forecasting of power plant operations follows the flowchart as outlined in FIG. 5. As shown, the process begins at step 500 by selecting a particular neural network model to be used (e.g., FFNN, Elman-RNN, Jordan-RNN, or another suitable network configuration), as well as the number of hidden layers to be included in the model and the number of nodes to be included in each layer. An activation function is also selected to characterize the operation to be performed on the weighted sum of inputs at each node. Lastly, an initial set of weights and bias values are used to initiate the process. In the iterative process of determining the proper weights and bias values for the selected neural network, it is important to initialize these parameters in a manner that will converge to acceptable results. In an exemplary embodiment of aspects of the present invention, a set of randomly distributed values is used. For the purpose of symmetry breaking, another exemplary embodiment includes initializing Wand b according to a normal distribution [symbol] (0,σ²) with a small perturbation σ=1. The cost function utilized during the supervised learning is as follows:

$$C ( W , b ; x , y ) = \frac{1}{2 m} {\sum }_{i = 1}^{m} {‖ h ( {x}^{( i )} ) - {y}^{( i )} ‖}_{2}^{2} .$$

Following this initialization, a historical time series set of data values associated with the particular operating parameter is selected for use in “training” the model (step 510). Various particular time series will be discussed in detail below and include, for example, energy load in kW-h over a time span of multiple hours, operating hours of a given turbine, the number of replacement rings required for a particular 12 month span, etc. The selected time series is defined as the “training information” and includes both the “training set” (defined by the variable “x” in the following discussion and “testing set” (defined by the variable “y” in the following discussion). This training information is further defined as “in-sample” data. It is possible, once the initial neural network modeling process is completed, to test this initial neural network model against what is referred to as a “validation” data set (that is, the next set of data following in the time series beyond the “testing” set). The use of the validation is considered as a final step to ensure that the model is accurate, but is considered optional.

Once all of the input information is gathered and the model is initialized, the training process continues at step 520 by computing the gradients associated with both the determined weights and bias values for this model. As will be explained in detail below, one approach to computing these gradients is to use a “backpropagation” method, which starts at the output of the network model and works backwards to determine an error term that may be attributed to each layer (calculating for each individual node in each layer), working from the output layer, through the hidden layers, and back to the input layer.

The next step in the process (shown as step 530) is to perform an optimization on all of the gradients generated in step 520, selecting an optimum set of weights and bias values that is defined as an “acceptable” set of parameters for the neural network model that best fits the time series being studied. As will be discussed below, it is possible to use more than one historical time series in this training process. With that in mind, the following step in the process is a decision point 540, which asks if there is another “training information” set that is to be used in training the model. If the answer is “yes”, the process moves to step 550, which defines the next “training information” set to be used, returning the process to step 520 to compute the gradients associated with this next set of training information.

Ultimately, when the total number of sets of training information to be used is exhausted, the process moves from step 540 to step 560, which inquires if there are multiple sets of optimized {W,b}. If so, these values are first averaged (step 570) before continuing. The next step (step 580) is to determine if there is a set of validation data that is to be used to perform one final “check” of the fit of the current neural network model with the optimized set {W,b} to a following set of time series values (i.e., the validation set).

If there is no need to perform this additional validation process, this final set of optimized {W,b} values are defined as the output from the training process and, going forward, are used in the developed neural network to perform the time series forecasting task (step 590).

If there is a set of validation data present, a final cost measurement is performed (step 600). If the predicted values from the model sufficient match the validation set values (at step 610), the use of this set of {W,b} values is confirmed, and again the process moves to step 590. Otherwise, if the validation test fails, it is possible to re-start the entire process by selecting a different neural network model (step 620) and returning to step 500 to try again to find a model that accurately predicts the time series under review.

With this understanding of the basic elements used to create a deep learning neural network useful in power plant operation forecasting, the various specific processes involved in performing the gradient computation and parameter optimization will be described in detail below. The following table includes a listing of the notations that will be used in this discussion:

TABLE I

| Notation | Definition |
|---|---|
| {x⁽ⁱ⁾, y⁽ⁱ⁾}ᵢ₌₁^{i=m} | Training information {training set, testing set} |
| | of m values of time series data |
| f | activation function (e.g., sigmoid function) |
| f′ | derivative function of the activation function |
| aⱼ^{(l)} | activation of node j in layer l, vector form: a^{(l)} |
| Wᵢⱼ^{(l)} | weight associated with the connection between node j |
| | in layer l to node i in layer l + 1, weight matrix |
| | form: W^{(l)} |
| bᵢ^{(l)} | weight of bias terms associated with node i in |
| | layer l + 1 |
| zⱼ^{(l)} | weighted sum of inputs to node j in layer l, |
| | vector form: z^{(l)} |
| L | total number of layers in the network |

With reference back to the basic feedforward neuron cell of FIG. 2, the relations between different parts in neuron cell 12 can be expressed in matrix form using the above notation:

z^{(l+1)}=W^{(l)}x⁽ⁱ⁾+b⁽ⁱ⁾,l=1,2, . . . ,L−1

a^{(l)}=f(z^{(l)}),l=1,2, . . . ,L

h(x⁽ⁱ⁾)=a(L).

Applying these equations to the energy load data set being studied, the forecasted output values can be calculated from the input values and the weights associated to those values.

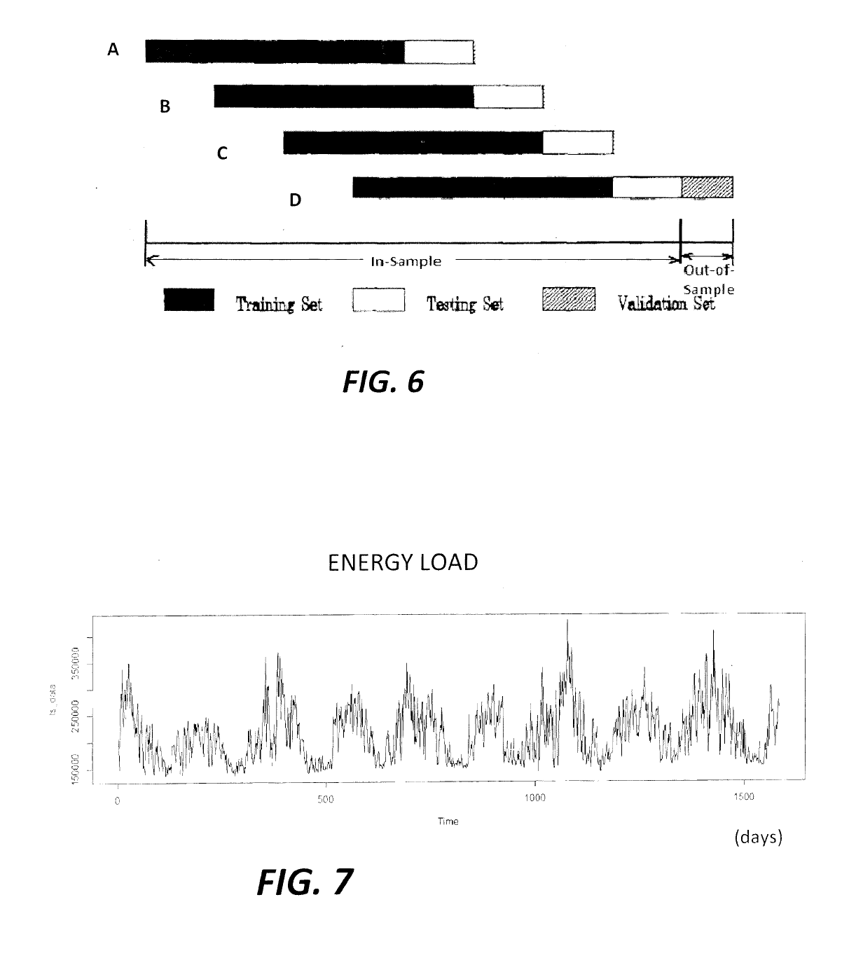

In accordance with aspects of the present invention, it is proposed to use a robust kind of training pattern in an exemplary embodiment of “learning” the best weights and bias values. In particular, it is proposed to use a dynamic, “walk forward” type of training routine, as shown in FIG. 6, as an exemplary way of using multiple sets of training information as discussed above. Referring to FIG. 6, this routine includes a type of sliding window training pattern, where each window uses a different section of the time series as the training set, followed by the testing set. This process begins by dividing the complete time series into series of overlapping training-testing sets, shown as overlapping sets A, B, C and D in FIG. 6. A single validation set is included at the end of the testing portion of set D. The training process is performed on each one of the separate overlapping sets in turn, starting with set A and progressing through set D. In this manner, an extra degree of reliability is created by performing the same modeling four separate times, where the four results are then averaged together to create the final result.

In artificial neural networks, there is a need to normalize the training set, since the output range of the neuron cell activation function is either [0,1] or [−1,1], depending on the particular function being used. In an exemplary embodiment, the training set and testing set are normalized at the same time in order to create the most accurate results, particularly when using a sliding window training pattern. The predicted time series embodying the actual values of the original series can then be recovered by performing the inverse operations used to perform the normalized scaling in the first instance.

The use of normalized inputs to the modeling process is also reasonable since there is no way to actually predict the exact range of the future, out-of-sample values, so the arrangement where the values are bounded by [0,1] or [−1,1] ensures that all values will remain in range.

In studying various neural network models to determine which particular model does the best job of accurately predicting future time series events associated with power plant operations (e.g., forecasting operating hours, energy load, parts replacement, etc.), different performance measures may be used to calculate the difference between the predicted values created by the artificial neural network model and the actual values.

Mean squared error (MSE) is usually applied to measure the discrepancy between the actual data and an estimation model, and is defined as:

$$M S E = \frac{1}{n} {\sum }_{t = 1}^{n} {( {F}_{t} - {A}_{t} )}^{2} ,$$

where the set {Aₜ} is the actual data values (and all ≧0) and the set {Fₜ} is the estimation model (i.e., prediction) values.

The root-mean-square error (RMSE) represents the sample standard deviation of the differences between the actual values and the predicted values. The RMSE can be computed by using:

$$R M S E = \sqrt{\frac{1}{n} {\sum }_{t = 1}^{n} {( {F}_{t} - {A}_{t} )}^{2}} .$$

Another measure, defined as the “mean absolute percentage error” (MAPE), is typically applied to measure the accuracy of a method for fitting time series values in statistics. In general, it is defined as a percentage, where

$$M A P E = \frac{1}{n} {\sum }_{t = 1}^{n} \vert \frac{{F}_{t} - {A}_{t}}{{A}_{t}} \vert ,$$

with the actual value of Aₜ>0. The RMSE and MAPE measures will be used in a later discussion for comparing various artificial neural network models created to predict future operating parameters of a power plant.

Recall that these various types of artificial neural networks are proposed to be used in accordance with aspects of the present invention to perform time series forecasting on various data sets associated with power plant management (e.g., operational hours, energy load, repair parts, etc.). Neural networks may be utilized to perform “single-step-ahead forecasting” or “multi-step-ahead forecasting”. The needs of time series forecasting in power plants are best served by utilizing multi-step-ahead forecasting. In this type of forecasting, there may be only a single output node (with the process looping through multiple iterations), or multiple output nodes (where the number of output nodes remains no greater than the number of forecasted steps).

The training algorithm is used to find the weights that minimize some overall error measure (such as MSE or MAPE). Hence, the network training is actually an unconstrained nonlinear minimization problem in which arc weights are iteratively modified to minimize the selected error measure. As described above in association with the flowchart of FIG. 5, one exemplary training algorithm is the “backpropagation algorithm”, which is essentially a gradient steepest descent method. That algorithm will now be described in more detail.

The general idea is to first run a “forward pass” through the network to compute all of the activations. Then the network is evaluated by looking back to the input layer from the output layer. For each node in each layer (starting with the output layer), an error term is computed that measures the contribution of that node to errors in the generated output value. By applying the backpropagation algorithm, it is possible to derive both the cost function value, as well as the gradient of the cost function for various combinations of arc weights and bias values, allowing the combination with the minimal cost to be defined as the “optimized” weights used going forward in the artificial neural network as configured to provide time series forecasting.

For the sake of discussion, the following discussion regarding the utilization of a training algorithm and the backpropagation process will be described for the relatively simple feedfoward neural network as shown in FIG. 2. The same principles apply when developing a training algorithm for various other types of neural networks (such as recurrent neural networks), but the complexity of the processes are considered to unnecessarily confuse the understanding of the basic principles of aspects of the present invention.

The detailed backpropagation algorithm is shown below:

Backpropagation Algorithm (Computing Gradients for W and b)—Algorithm 1

| | |
|---|---|
| 1. | Initialize with: (1) {W^{l}, b^{(l)}}_{l = 1}^{L -1} from the previous iteration (or random values for first iteration); |

(2) known training set {x⁽ⁱ⁾, y⁽ⁱ⁾}_{i = 1}^{i =} ^{m}; and (3) regularization parameter λ. Set C^{(l}_{DW} = 0, and C^{(l)}_{Db} = 0.

| 2. | for i = 0 to m do | |
|---|---|---|
| 3. | for l = 2 to L do | |
| | | z^{(l)} ← W^{(l)}x⁽ⁱ⁾ + b^{(l -1)}, a^{(l)} ← f(z^{(l)}). |
| 4. | end for | |
| 5. | Set h(x^{(l)}) ← a^{(L)}. | |
| 6. | For layer L, set | |
| | | δ^{(L)} ← (a^{(L)} − y⁽ⁱ⁾) ∘ f′(z^{(L)}). |
| 7. | for l = L − 1 to 2 do | |
| 8. | For layer l, set | |
| | | δ^{(l)} ← ((W^{(l)})^{T} δ^{(l + 1)}) ∘ f′(z^{(l)}). |
| 9. | end for | |
| 10. | for l = 1 to L − 1 do | |
| 11. | Compute the partial derivatives: | |
| | | C_{W} ← δ^{(l +} ¹⁾(a^{(l)})^{T}, C_{b} ← δ^{(l +} ¹⁾ |
| 12. | end for | |
| 13. | for l = L − 1 to 2 do | |
| 14. | Update the gradient components for each layer to the entire gradients (C_{DW}, C_{Db}) | |
| | | C_{DW}^{(l)} ← C_{DW}^{(l)} + C_{W}^{(l)}; C_{Db}^{(l)} ← C_{Db}^{(l)} + C_{b}^{(l)}. |

| | |
|---|---|
| 15. | end for |
| 16. | end for |

Return the gradients: for all l = 1, . . . , L − 1, for

${∇}_{{W}^{( l )}} C ( {W}^{( l )} , {b}^{( l )} ; x , y ) := \frac{1}{m} {C}_{DW} + λ {W}^{( l )} ,$
${∇}_{{b}^{( l )}} C ( {W}^{( l )} , {b}^{( l )} ; x , y ) := \frac{1}{m} {C}_{Db} .$

The key is to back-propagate the error terms from the output layer of the neural network model to the input layer, computing the gradient associated with both the weights and the bias terms along the way.

Following this process, the next step is to perform some type of optimization on the gradient values to determine the best-fit values for {W,b} in the model. Various types of optimization processes can be used, where the goal is to minimize the cost function. While this optimization problem is a non-convex unconstrained problem, various well-known optimization algorithms are able to provide useable results, where the derivative-based methods are generally considered as an appropriate alternative. For the derivative-based algorithms, the only information that is required is the iteration gradients. An example of a derivative-based gradient descent algorithm for selecting the optimized {W,b} values is shown below:

Optimizing {W,b} with Gradient Descent - Algorithm 2

```
1. Initialize with an initial {W^{(l)},b^{(l)} }ₗ₌₁^{L-1} and a constant step size α
2. for i =0 to T do
3. Compute gradients (∇_{W}^{(l)}C(W^{(l)},b^{(l)}); ∇_{b}^{(l)}C(W^{(l)},b^{(l)})),
      using Algorithm 1 for l = 1, ... L−1
4. Update current iterates for each l = 1, ..., L−1
            W^{l} ← W^{l} − α∇_{W}^{(l)}C(W^{(l)},b^{(l)}); and
                b^{(l)} ← α∇_{b}^{(l)}C(W^{(l)},b^{(l)})
5. end for
  Return Optimal solution for {(W^{(l)},b^{(l)}}ₗ₌₁^{L-1}
```

This process of obtaining the “optimal solution” for {W,b} typically converges within a relatively few iterations.

When satisfied that the model adequately fits the validation set values, the created artificial neural network is ready to be used for the specific power plant operation forecasting assignment, with the optimal set of {W,b} defined above utilized within the network.

In particular, the feedforward neural network for predicting future values of the time series associated with power plant operations can be expressed as follows in Algorithm 3:

Feedforward Neural Network (Predicting) - Algorithm 3

```
    1. Initialize with: (1) optimal {(W^{(l)},b^{(l)}}ₗ₌₁^{L-1} from gradient
    descent process (Algorithm 2); and
(2) predicting inputs {x⁽ⁱ⁾}ᵢ₌₁^{i=p} (the “predicting inputs” being
the power plant time series under study)
    2. for i = 0 to m do
    3. for l = 2 to L do
                z^{(l)} ← W^{(l)}x⁽ⁱ⁾ + b^{(l-1)}, a^{(l)} ← f(z^{(l)}).
    4. end for
    5: Set y_{pred}⁽ⁱ⁾ := h(x⁽ⁱ⁾) ← a^{(L)},
    6: end for
      return Predicted values: {y_{pred}⁽ⁱ⁾}ᵢ₌₁^{i=p}.
```

In order to evaluate the applicability of artificial neural network techniques described thus far to power plant-related time series forecasting, a set of historical data collected for a known power plant was used. FIG. 7 is a time series plot of the actual daily energy load generated over a period of 1586 days. The intent of aspects of the present invention is to use the deep learning methodology of artificial neural network techniques to forecast future values of energy load based upon this data. The power plant operations personnel then uses this predicted energy load to properly schedule the equipment (including turbines, spare parts, etc.) and input fuel sources requirement to meet this predicted energy load value.

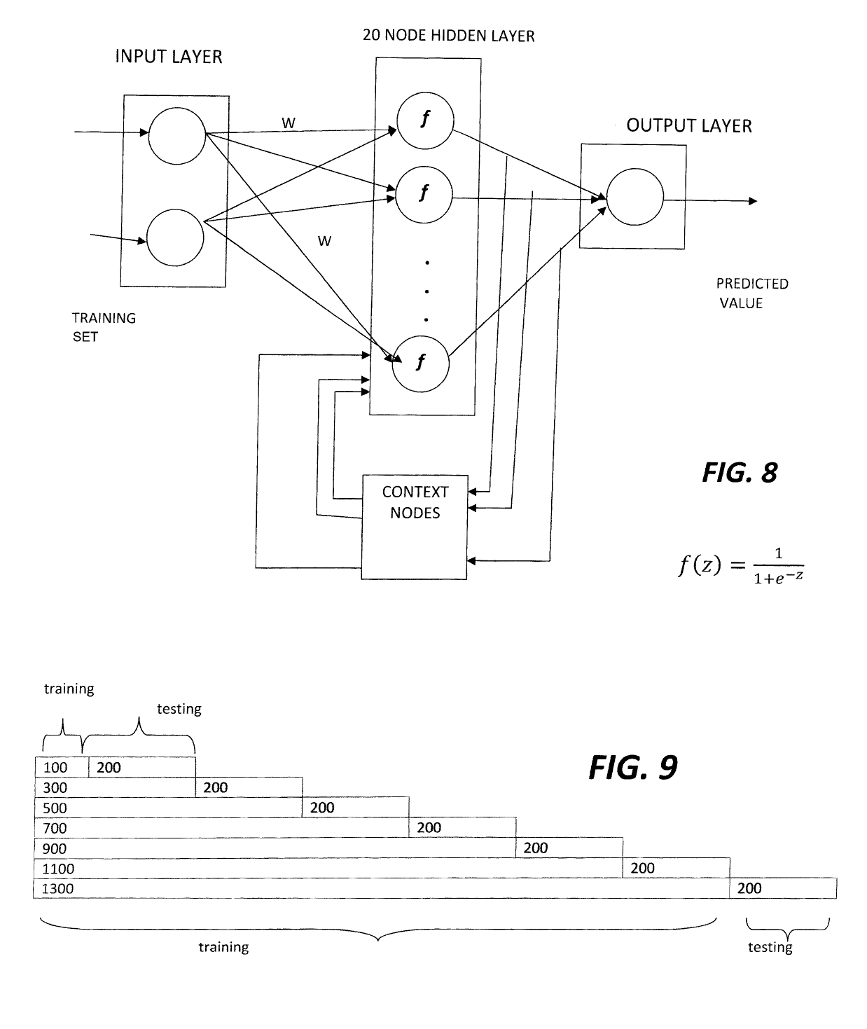

In exploring the applicability of artificial neural networks to power plant operations forecasting, a number of different scenarios were developed for study. Parameters such as the size of the training set, size of the testing set, single-vs. multi-step-ahead networks, different artificial neural network types, different complexities, etc., were studied. Except for those scenarios where different types of networks were evaluated, the other experiments used the artificial neural network configuration shown in FIG. 8. This network takes the form of an Elman-RNN (of the type shown in FIG. 3) with a single hidden layer, the hidden layer containing a set of 20 neurons. The sigmoid function was used as the activation function.

The first set of experiments evaluated the impact of the size of the training set on the accuracy of the model. FIG. 9 depicts the different combinations used, ranging from a training set of 100 datapoints to a training set of 1300 datapoints, where in each case the size of the testing set was held fixed at the value of 200 datapoints. The predicted values from the testing set of each model were then compared to the validation set (where the “validation set” was defined as the 86 time series values following the testing set).

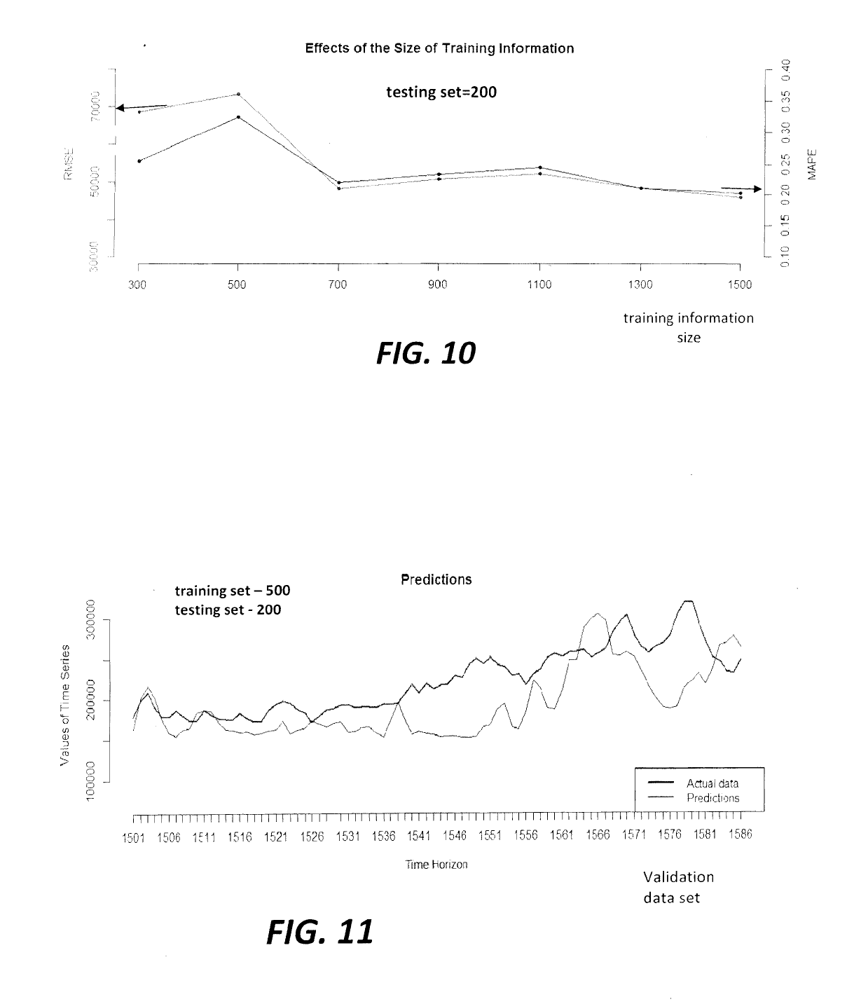

The following table gives an illustration of how the RSME and MAPE measures behaved when applied to the validation data set as a function of the size of the training information (i.e., for each different size of training set data). Again, these experiments were performed using the time series data of energy load shown in FIG. 7. FIG. 10 is a graph depicting the results shown in Table II.

TABLE II

| | Size of Training Information (training set and testing set) | | | | | | |
|---|---|---|---|---|---|---|---|
| | 300 | 500 | 700 | 900 | 1100 | 1300 | 1500 |
| RMSE | 68445.86 | 7338.72 | 48173.13 | 50829.9 | 52344.98 | 48422.24 | 45928.03 |
| MAPE | 0.2546837 | 0.3233143 | 0.2192471 | 0.2326607 | 0.243762 | 0.2105482 | 0.2020296 |
| Training | 67.77 | 73.28 | 85.15 | 89.34 | 111.17 | 207.16 | 116.58 |
| Time | | | | | | | |
| (sec) | | | | | | | |

As shown in FIG. 10 and Table II, as the size of the training set increases, the values of RMSE and MAPE decrease. It is reasonable that the two measures are not strictly decreasing, since as the size of the training set increases, some overfitting will undoubtedly occur. Thus, increasing the size of the training set beyond a certain level may result in being counterproductive. As shown in Table II, the training time also tends to increase as the size of the training set increases, which is to be expected.

FIG. 11 is a plot showing the correspondence between the “best” predicted (forecasted) energy load values for time steps 1501-1586 and actual data values for this time period (that is, the validation set). These predictions used a training set size of 500, and achieved a MAPE of 20%. As evident from the plot of FIG. 11, these predictions were able to generally follow the data trends (although the later in time predicted values did not fit the actual data as well as the initial time steps).

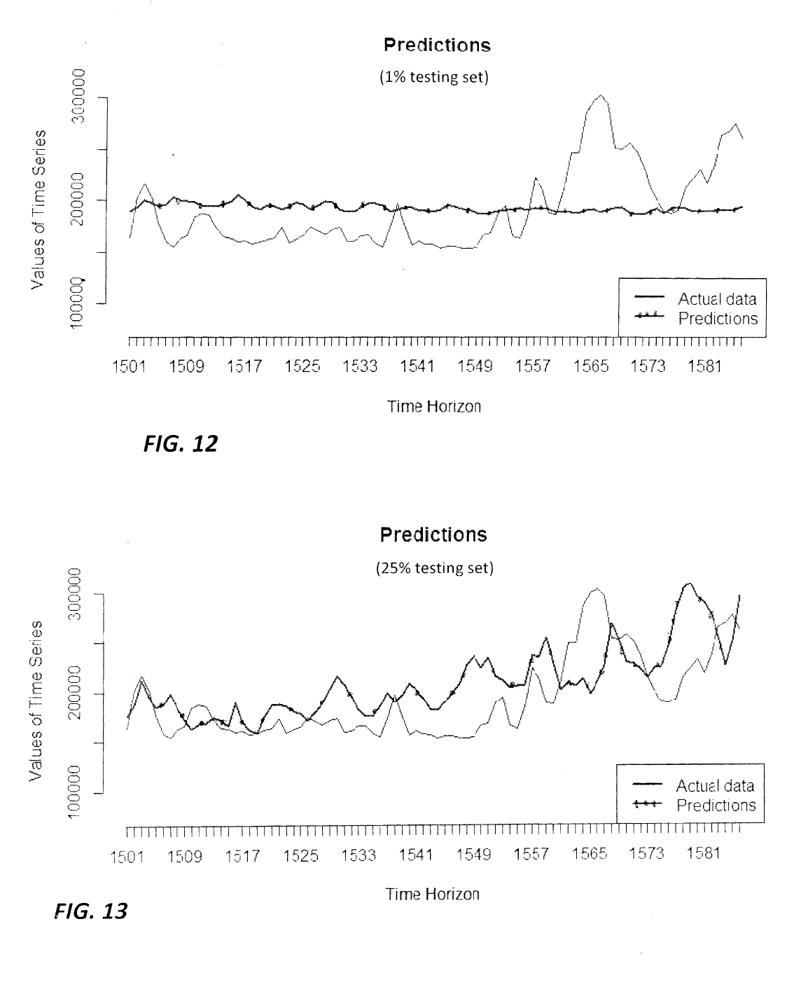

The above results were determined for a fixed size testing set of 200 data points. It is also important to understand the effects of different sizes of testing sets on the accuracy of the forecasted results. Table III and associated FIGS. 12-15 contain results of experiments where the size of the testing set was varied from between 1% to 90% of the total of the in-sample training information data. As with the above experiments, the neural network configuration of FIG. 8 was used. The single-step-ahead forecasting was prepared, and the results are shown in Table III:

TABLE III

| | Testing set size | | | | | | |
|---|---|---|---|---|---|---|---|
| | 1% | 5% | 10% | 15% | 20% | 25% | 30% |
| RMSE | 41821.87 | 46518.28 | 55356.6 | 53831.67 | 40792.35 | 40315.58 | 50534.69 |
| MAPE | 0.1728515 | 0.2271389 | 0.269355 | 0.255320 | 0.1843817 | 0.1667428 | 0.2206298 |
| Training time | 4.82 | 54.26 | 76.70 | 112.87 | 129.48 | 257.60 | 284.05 |
| (sec) | | | | | | | |
| | Testing set size | | | | | | |
| | 35% | 40% | 50% | 60% | 70% | 80% | 90% |
| RMSE | 69964.23 | 56989.35 | 49112.28 | 72425.75 | 85462.19 | 85271.72 | 34071.91 |
| MAPE | 0.3368892 | 0.2762132 | 0.2181365 | 0.316411 | 0.3371335 | 0.3725771 | 0.1343885 |
| Training time | 308.23 | 370.59 | 440.19 | 696.30 | 663.72 | 655.79 | 74.09 |
| (sec) | | | | | | | |

From a review of the measures in Table III, it appears that using a testing set size of 1% yields relatively acceptable results, given the RMSE and MAPE measures. FIG. 12 is a graph showing the actual data of the validation set (i.e., the final 86 time steps in the series of FIG. 7) in comparison to the values predicted using this 1% testing set. Clearly, the 1% size for the testing set is not sufficient for providing a credible predicted value. While the 1% size yields acceptable RMSE and MAPE values, it is shown in FIG. 12 to give a flat series of predictions and is not able to catch the trends appearing in the later data values (i.e., from about 1557 onward).

In contrast to the 1% size of the testing set, the use of a 25% size for the testing set provides a better fit to the actual data, as shown in FIG. 13. As shown, the predictions are able to follow the trend in the later values of the validation data set. Referring to Table III, it is shown that the RMSE and MAPE values for the 25% size testing set are somewhat higher than the 1% values, but are still acceptable. It is shown that the use of an increased size testing set allows for future trends to be recognized and included in creating the model.

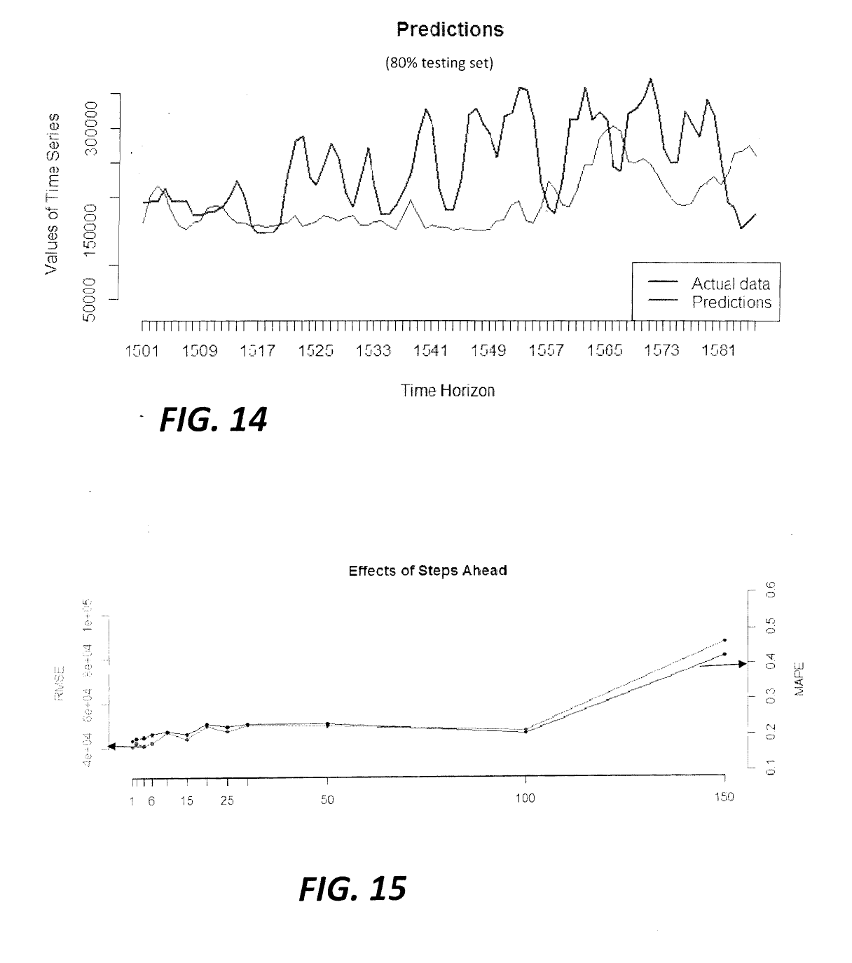

On the other hand, it is also possible to include too much data in the testing set. This is obvious from the plot of FIG. 14, which illustrates the predicted values generated by using an 80% size of the testing set, as well as from the RMSE and MAPE values for 80% shown in Table III. Here, the problem of the predicted values tending to overfit the actual values causes large fluctuations from one value to the next.

Summarizing, an exemplary embodiment of aspects of the present invention utilizes a testing set (in-sample) size in the range of about 10-25%. A smaller testing set causes insufficient data for evaluating the cost functions, giving rising to the risk of losing trends in the series. Meanwhile, testing set sizes above 25% can possibly result in overfitting.

The experiments described thus far have all been based upon the “single-step-ahead” model (as shown in FIG. 8), for the sake of simplicity. By intuition, it would be more accurate to predict one step ahead each time, since the most recent information is being used to predict only the next step. However, as discussed above, the application of artificial neural networks using deep learning techniques in the field of forecasting power plant operations is better suited to the multiple-step-ahead model. It is contemplated that the multi-step-ahead networks should take less training time, since each iteration of the algorithm produces multiple time values.

Using the same time series shown in FIG. 7, a set of experiments was performed where the number of “steps ahead” was varied between a single step and 150 steps. The neural network arrangement of FIG. 8 was used, with the number of output nodes increased for each different evaluation. For these experiments the size of the training information was held fixed at 1500, with the first 1200 values defined as the training set and the remaining 300 values (i.e., a 20% size) defined as the testing set (again, the validation set was fixed at 86). Table IV illustrates the RMSE and MAPE measures associated with the validation set for different numbers of steps ahead.

TABLE IV

| | Number of steps | | | | | |
|---|---|---|---|---|---|---|
| | 20 | 25 | 30 | 50 | 100 | 150 |
| | 1 | 2 | 4 | 6 | 10 | 15 |
| RMSE | 40792.35 | 42510.62 | 41255.23 | 42498.24 | 47013.79 | 44105.34 |
| MAPE | 0.1843817 | 0.191471 | 0.1937132 | 0.2010987 | 0.2107779 | 0.2012938 |
| Training time | 124.32 | 70.91 | 51.17 | 24.63 | 21.12 | 29.93 |
| (sec) | | | | | | |
| | Number of steps | | | | | |
| | 20 | 25 | 30 | 50 | 100 | 150 |
| RMSE | 49860.25 | 47589.34 | 50385.57 | 50044.31 | 47935.7 | 87895.27 |
| MAPE | 0.2301466 | 0.2228051 | 0.2302882 | 0.2307589 | 0.2041059 | 0.4220594 |
| Training time | 8.57 | 6.67 | 4.97 | 3.82 | 3.39 | 2.67 |
| (sec) | | | | | | |

FIG. 15 is a plot of the data shown in Table IV, plotting the measured values of both RMSE and MAPE as a function of the number of steps ahead. The trends of both measures suggest that fewer steps ahead networks yield better predictions, at least for this case where a relatively large set of training information is used (i.e., 1500 values).

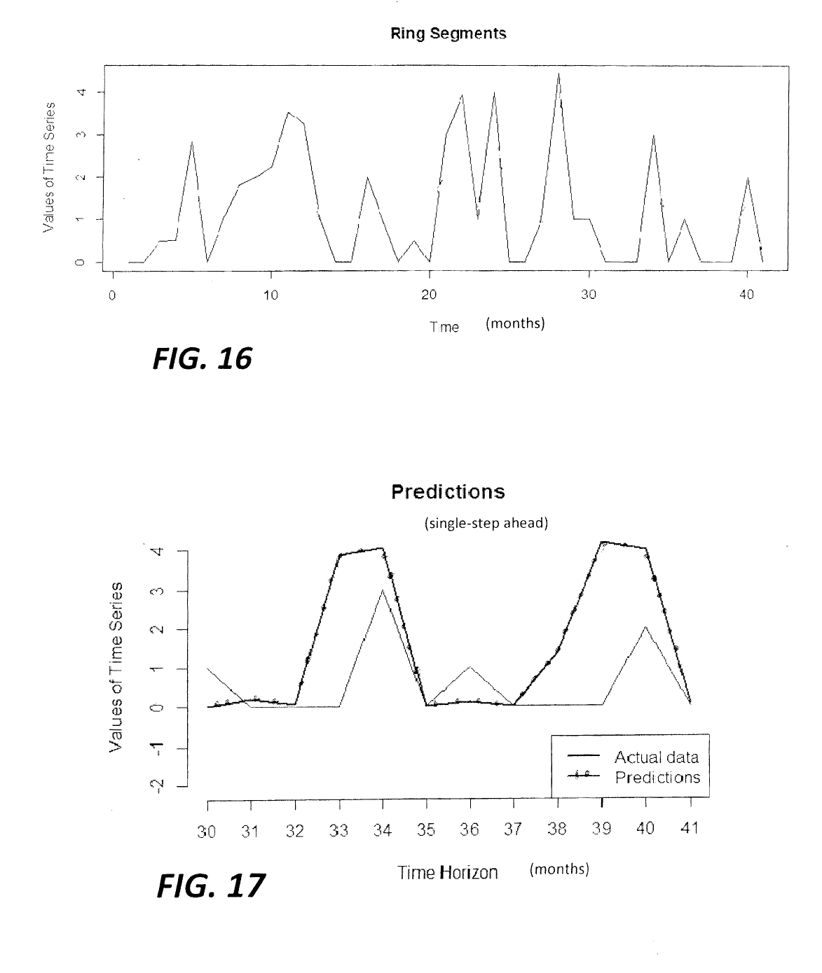

It is thus of interest to understand how the size of the training information impacts the parameters of the neural network utilized to forecast future values of a smaller (shorter) time series. For example, FIG. 16 contains a plot of data collected over a time period of 41 months, showing the number of gas turbine ring segments that required replacement for a given power plant over this time span. In evaluating this data, the same recurrent neural network as shown in FIG. 8 was studied. As a result of the limited size of the data set, only 12 values were used to form the testing set, and an additional 12 values were used to form the validation set. The number 12 selected so as to allow for year-long planning to be performed. Table V shows the RMSE measures for this “small” data set, created for a number of different “step-ahead” embodiments. Inasmuch as the MAPE measure cannot be calculated for series exhibiting values of “0” (which is the case here), only the RMSE is used:

TABLE V

| | Number of steps ahead | | | | | |
|---|---|---|---|---|---|---|
| | 1 | 2 | 3 | 4 | 6 | 12 |
| RMSE | 1.857905 | 1.367206 | 1.479983 | 1.641795 | 1.445662 | 1.553975 |
| Training time | 5.33 | 2.98 | 3.04 | 4.81 | 2.30 | 1.05 |
| (sec) | | | | | | |

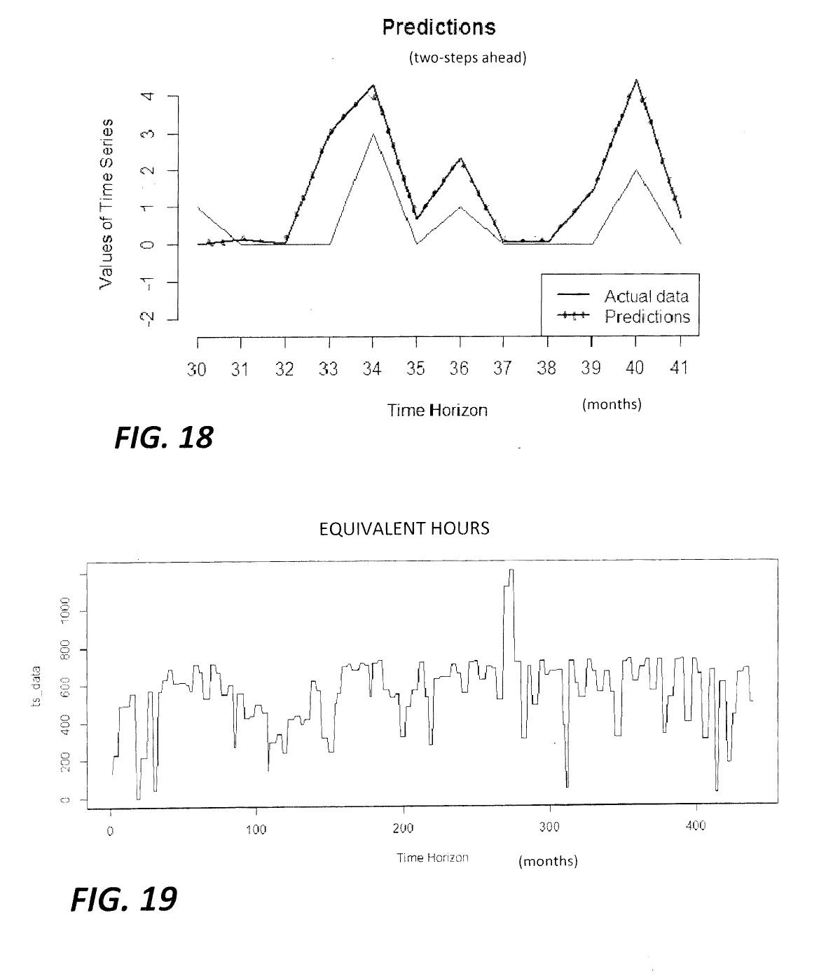

In this case of a small data set, it is shown in Table V that each one of the multi-step step-ahead models out-performs the single-step-ahead model. It is also reasonable that the greater number of steps ahead being calculated, the less the training time required to converge on a model. FIG. 17 is a plot comparing the predicting values for months 30-41 to the actual values recorded for ring segment replacement during this time period, based on the single-step-ahead configuration. The plot shown in FIG. 18 is associated with the two-step ahead configuration. It is clearly shown that the two-step-ahead model precisely predicts the hill at time step 36, while the single-step-ahead model does not find this trend. The overall accuracy of the two-step model is also more accurate at the other time steps shown in the plots.

Another parameter worthy of consideration when building an artificial neural network model that best forecasts future values is whether to use a feedforward network (such as shown in FIG. 2) or a recurrent network (two different examples of which being shown in FIGS. 3 and 4). A different time series of power plant data was used in this analysis. In particular, FIG. 19 is a plot of equivalent hours of power plant operation over a time period of 439 months and was used for this analysis since it contained somewhat fewer values than the energy load values studied above, yet with enough data to yield valid results. For these experiments, a validation set of 36 was chosen (i.e., a three year period of time). Of the 403 initial values, 75% of this total was used as the training set (i.e., about 302 values), and the remaining 102 values were used as the testing set. The predictions were determined by using a single-step-ahead model.

The corresponding measures for RMSE and “complexity” are shown in Table VI. For this purpose, the term “complexity” refers to the number of hidden nodes in each neural network layer that contains hidden nodes. The label FFNN1 denotes a feedforward neural network with a single hidden layer, FFNN2 denotes a feedforward neural network with a pair of hidden layers, RNN_E denotes the Elman recurrent network shown in FIG. 3, and RNN_J denotes the Jordan recurrent network shown in FIG. 4.

TABLE VI

| Network | FFNN1 | FFNN2 | RNN_E | RNN_J |
|---|---|---|---|---|
| Complexity | 9421(30) | 9515 (28, 25) | 9577 (28) | 9451 (30) |
| RMSE | 358.4781 | 184.4349 | 350.8019 | 338.9499 |

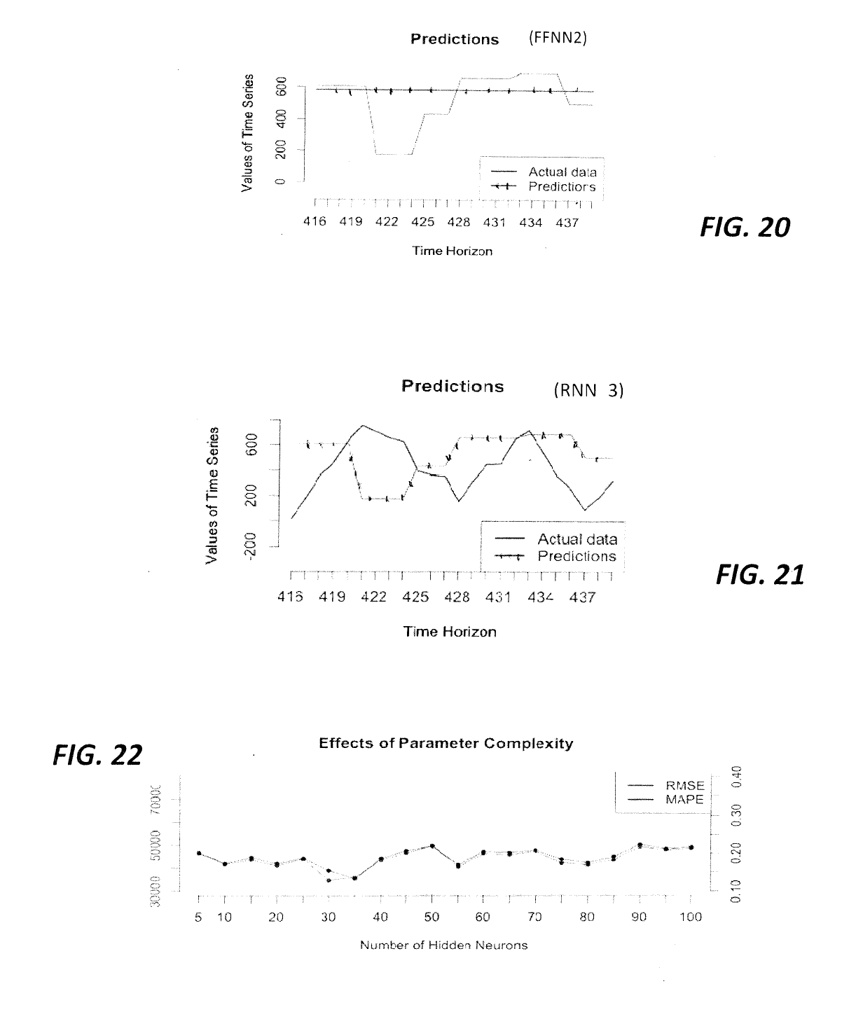

By reviewing the RMSE values in Table VI, it would be concluded that the FFNN2 model provides the best fit to the equivalent hours data shown in FIG. 19. However, by checking the actual plots of predicted values against the validation set, it is shown that the RNN_E model yields the best results. FIGS. 20 and 21 contain plots of predictions and actual values for the validation period data set (i.e., months 416-439). FIG. 20 is a plot of the predictions generated by the FFNN2 value. As shown, while the RMSE value for this plot is relatively small, its ability to predict the data values is not acceptable (exhibiting a flat level of predicted values). FIG. 21 is a plot created for the RNN_E model, showing a somewhat improved result. In most circumstances, it can be presumed that a recurrent network, which includes additional input information, will provide a more accurate prediction than the basic feedforward neural network.

Yet another factor to be considered in developing the most appropriate neural network model to use in forecasting power plant operating parameters is the number of hidden neurons/layers to be included in the model (referred to as the “complexity” of the model). FIG. 22 is a plot of the numerical results for the time series shown in FIG. 7, where the number of hidden neurons is varied between 5 and 100. The RMSE and MAPE measures were both calculated for each of the different sets of hidden neurons. The higher RMSE and MAPE values for larger numbers of hidden neurons (above about 40, for example) is a result of the larger parameter complexity as compared to the size of the training set, resulting in overfitting problems.

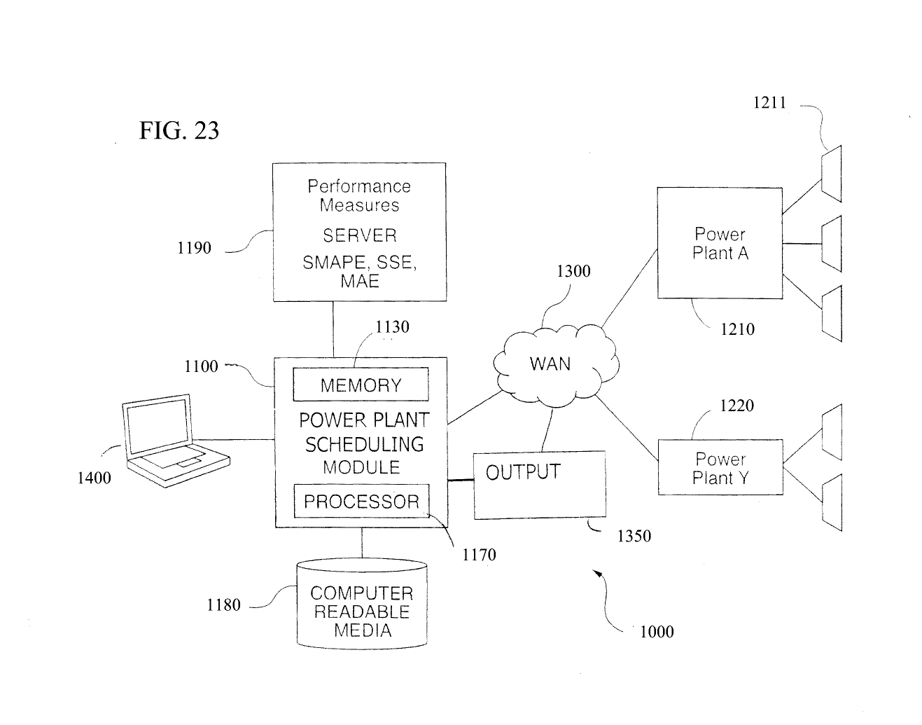

The elements of the deep learning neural network methodology as described above may be implemented in a computer system comprising a single unit, or a plurality of units linked by a network or a bus. An exemplary system 1000 is shown in FIG. 23, and in this case illustrates the use of a single computer system providing scheduling control for a multiple number of different power plants. As shown, a power plant scheduling module 1100 is connected to multiple power plants (shown here as elements 1210 and 1220) via a wide area data network 1300.

Power plant scheduling module 1100 may be a mainframe computer, a desktop or laptop computer or any other device capable of processing data. Scheduling module 1100 receives time series data (TSD) from any number of associated power plants (e.g., 1210, 1220), where the data from each plant may comprise, for example, operating hours for each turbine at each plant, energy load demand for each power plant, a number of replacements required for various mechanical parts of each turbine at each power plant, and the like. The received time series data also carries identification information associated with the specific power plant sending the data, as well as a specific gas turbine (shown as elements 1211 in FIG. 23) if turbine-specific data is being collected.

Scheduling module 1100 is then used to perform a selected “forecasting” process (as instructed by personnel operating the power plant(s)), based upon the received time series data and generate a “prediction” for a future number of time steps based on the process (using the artificial neural network technique described above). The power plant personnel utilizes this prediction information to create a “scheduling” message that is thereafter transmitted to the proper power plant. For example, if scheduling module 1100 has performed a forecasting process of predicting future energy demand at power plant 1220 for the next 24 hours, the generated results of the process may then be used by the power plant personnel to “schedule” the proper number of turbines to be energized to meet this forecasted demand. The return information flow from an output device 1350 to the power plants is simply referred to as “schedule” in FIG. 23, with the understanding that the results may include events such as scheduling a proper number of replacement parts to be ordered, scheduling a maintenance event for a given turbine (based on predicted operating hours), etc.

A memory unit 1130 in scheduling module 1100 may be used to store the information linking specific identification codes with specific turbines and/or specific power plants. Additionally, memory unit 1130 may be used to store the various neural network modules available for use, the activation functions, and other initialization information required in creating and using artificial neural networks in providing the power plant scheduling information in accordance with aspects of the present invention.

The steps required to perform the inventive method as outlined in the flowchart of FIG. 5, including Algorithms 1, 2, and 3 described above, may be included in one or more processors 1170, which may form a central processing unit (CPU). Processor 1170, when configured using software according to aspects of the present disclosure, includes structures that are configured for creating and using a specific artificial neural network model that best provides a forecast useful in scheduling future power plant operations for the specific operating system parameter currently under study (e.g., determining a number of turbines to be active to meet a forecasted demand at a particular power plant, determining a number of replacement parts to order for another particular power plant, etc.).

Memory unit 1130 may include a random access memory (RAM) and a read-only memory (ROM). The memory may also include removable media such as a disk drive, tape drive, memory card, etc., or a combination thereof. The RAM functions as a data memory that stores data used during execution of programs in processor 1170; the RAM is also used as a program work area. The various performance measures used in the process of aspects of the present invention may reside in a separate server 1190, accessed by module 1100 as necessary. The ROM functions as a program memory for storing programs (such as Algorithms 1, 2, and 3) executed in processors 1170. The program may reside on the ROM or on any other tangible or non-volatile computer-readable media 1180 as computer readable instructions stored thereon for execution by the processor to perform the methods of the invention. The ROM may also contain data for use by the program or by other programs.

The individual personnel using the methodology of aspects of the present invention may input commands to system 1000 via an input/output device 1400, which may be directly connected to scheduling module 1100, or connected via a separate WAN (not shown).

The above-described method may be implemented by program modules that are executed by a computer, as described above. Generally, program modules include routines, objects, components, data structures and the like that perform particular tasks or implement particular abstract data types. The term “program” as used herein may connote a single program module or multiple program modules acting in concert. The disclosure may be implemented on a variety of types of computers, including personal computers (PCs), hand-held devices, multi-processor systems, microprocessor-based programmable consumer electronics, network PCs, mini-computers, mainframe computers, and the like. The disclosure may also be employed in distributed computing environments, where tasks are performed by remote processing devices that are linked through a communications network. In a distributed computing environment, modules may be located in both local and remote memory storage devices.

An exemplary processing module for implementing the inventive methodology as described above may be hard-wired or stored in a separate memory that is read into a main memory of a processor or a plurality of processors from a computer-readable medium such as a ROM or other type of hard magnetic drive, optical storage, tape or flash memory. In the case of a program stored in a memory media, execution of sequences of instructions in the module causes the processor to perform the process steps described herein. The exemplary embodiments of aspects of the present disclosure are not limited to any specific combination of hardware and software and the computer program code required to implement the foregoing can be developed by a person of ordinary skill in the art.

The term “computer readable medium” as employed herein refers to any tangible machine-encoded medium that provides or participates in providing instructions to one or more processors. For example, a computer-readable medium may be one or more optical or magnetic memory disks, flash drives and cards, a read-only memory or a random access memory such as a DRAM, which typically constitutes the main memory. Such media excludes propagated signals, which are not tangible. Cached information is considered to be stored on a computer-readable medium. Common expedients of computer-readable media are well-known in the art and need not be described in detail here.

What is claimed is:

1. A method of scheduling future power plant operations based on a set of time series data associated with a specific power plant operation, the method comprising:
selecting an artificial neural network model for use in evaluating the set of time series data, the selected artificial neural network model including at least one hidden layer between an input layer and an output layer, the input layer for receiving a set of time series datapoints and the output layer for generating one or more predicted time series values;
initializing the selected artificial neural network model by defining a number of nodes to be included in each layer, an activation function for use in each neuron cell node in each layer, and a number of bias nodes to be included in each layer;
training the selected artificial neural network model to develop an optimal set of weights for each signal propagating through the network model from the input layer to the output layer, and an optimal set of bias node values;
defining the trained artificial neural network as a prediction model for the set of time series data under study;
applying a newly-arrived set of time series data to the prediction model;
generating one or more predicted time series data output values from the prediction model; and
scheduling an associated operation event at the specific power plant based on the predicted time series data output values.

2. The method as defined in claim 1 wherein the specific power plant operation is selected from a group comprising: operating hours of each individual turbine at a power plant, energy load demand of a power plant, replacement rates for selected mechanical components of power plant equipment.

3. The method as defined in claim 2 wherein in performing the scheduling of an associated operation event, the event includes scheduling a selected number of turbines to be energized when the specific power plant operation is energy load demand and the predicted time series output is a predicted energy load demand for a following period of time.

4. The method as defined in claim 2 wherein in performing the scheduling of an associated operation event, the event includes scheduling a maintenance event for a predefined turbine when the specific power plant operation is operating hours for the predefined turbine and the predicted time series output is a predicted number of future operating hours for the predefined turbine.

5. The method as defined in claim 1 wherein the artificial neural network model comprises a type of feedforward neural network model or a type of recurrent neural network model.

6. The method as defined in claim 5 wherein the selected artificial neural network model comprises a feedforward neural network model with no greater than two hidden layers.

7. The method as defined in claim 5 wherein the selected artificial neural network model comprises a recurrent neural network model with a plurality of feedback paths coupled from outputs of a hidden layer to the input layer.

8. The method as defined in claim 5 wherein the selected artificial neural network model comprises a recurrent neural network model with a plurality of feedback paths coupled from outputs of the output layer to the input layer.

9. The method as defined in claim 1 wherein initializing the selected artificial neural network model includes selecting a sigmoid function as the activation function for the selected artificial neural network.

10. The method as defined in claim 1 wherein training the selected artificial neural network model includes using a backpropagation process to determine an error value associated with each node in the selected artificial neural network and performing the process in an iterative fashion to determine a set of gradients for each of the weights and bias values for each node in the neural network.

11. The method as defined in claim 10 wherein the set of gradients for each of the weights and bias values are processed through a gradient descent value to derive the optimal weight and bias node values.

12. The method as defined in claim 1 wherein training the selected artificial neural network model includes defining a portion of the time series data as a training information set, including a first portion defined as the training set and a second portion defined at the testing set.

13. The method as defined in claim 12 wherein the training set includes a larger number of datapoints than the testing set.

14. The method as defined in claim 13 wherein the testing set is in the range of approximately 10-25% of the training information set.

15. A system for predicting future values of time series data associated with power plant operation and scheduling a future event based on the predictions comprising
a scheduling module responsive to input instructions for performing a selected power plant operation forecast, the scheduling module including
a memory element for storing time series data transmitted from one or more power plant to the scheduling module;
a processor and a program storage device, the program storage device embodying in a fixed tangible medium a set of program instructions executable by the processor to perform a method comprising:
selecting an artificial neural network model for use in evaluating the set of time series data, the selected artificial neural network model including at least one hidden layer between an input layer and an output layer, the input layer for receiving a set of time series datapoints and the output layer for generating one or more predicted time series values;
initializing the selected artificial neural network model by defining a number of nodes to be included in each layer, an activation function for use in each neuron cell node in each layer, and a number of bias nodes to be included in each layer;
training the selected artificial neural network model to develop an optimal set of weights for each signal propagating through the network model from the input layer to the output layer, and an optimal set of bias node values;
defining the trained artificial neural network as a prediction model for the set of time series data under study;
applying a newly-arrived set of time series data to the prediction model;
generating one or more predicted time series data output values from the prediction model; and
an output device operable to provide the predicted time series data to power plant personnel for scheduling a future power plant operation based on the predicted time series data.

16. The system as defined in claim 15 wherein the artificial neural network model comprises a type of feedforward neural network model or a type of recurrent neural network model.

17. The system as defined in claim 15 wherein the processor of the scheduling module performs training of the selected artificial neural network by using a backpropagation algorithm stored within the program storage device.

18. A computer program product comprising a non-transitory computer readable recording medium having recorded thereon a computer program comprising instructions for, when executed on a computer, instructing said computer to perform a method for scheduling future power plant operations based on a set of time series data associated with a specific power plant operation, the method comprising:
selecting an artificial neural network model for use in evaluating the set of time series data, the selected artificial neural network model including at least one hidden layer between an input layer and an output layer, the input layer for receiving a set of time series datapoints and the output layer for generating one or more predicted time series values;
initializing the selected artificial neural network model by defining a number of nodes to be included in each layer, an activation function for use in each neuron cell node in each layer, and a number of bias nodes to be included in each layer;
training the selected artificial neural network model to develop an optimal set of weights for each signal propagating through the network model from the input layer to the output layer, and an optimal set of bias node values;
defining the trained artificial neural network as a prediction model for the set of time series data under study;
applying a newly-arrived set of time series data to the prediction model;
generating one or more predicted time series data output values from the prediction model; and
scheduling an associated operation event at the specific power plant based on the predicted time series data output values.

19. The computer program product as defined in claim 18 wherein training the selected artificial neural network model includes using a backpropagation process to determine an error value associated with each node in the selected artificial neural network and performing the process in an iterative fashion to determine a set of gradients for each of the weights and bias values for each node in the neural network.

20. The computer program product as defined in claim 18 wherein training the selected artificial neural network model includes defining a portion of the time series data as a training information set, including a first portion defined as the training set and a second portion defined at the testing set.
